(19) United States
(12) Patent Application Publication
(10) Pub. No.: US 2012/0249929 A1
(43) Pub. Date: Oct. 4, 2012

(54) REFLECTIVE DISPLAY PANEL

(75) Inventors: Makoto FUKUDA, Kawasaki (JP); Hirokazu Aritake, Kawasaki (JP); Kenichi Ashikawa, Kawasaki (JP)

(73) Assignee: FUJITSU LIMITED, Kawasaki-shi (JP)

(21) Appl. No.: 13/406,968

(22) Filed: Feb. 28, 2012

(30) Foreign Application Priority Data
Mar. 29, 2011 (JP) 2011-071704

(51) Int. Cl. G02F 1/1335; G02F 1/1347; G02F 1/19

(52) U.S. Cl. 349/74; 359/263; 349/106

(57) ABSTRACT

A display panel includes: a reflective display panel including: two substrates disposed so as to face each other; transparent electrodes formed over each of the two substrates; and a reflective material layer, sealed between the two substrates, including a reflection state which changes based on a voltage applied between the transparent electrodes; a light absorption layer disposed on a first surface side of the reflective display panel; and a cut-off filter layer disposed on a second surface side of the reflective display panel, wherein, in a visible wavelength range, a wavelength at which reflection from the transparent electrodes is smallest overlaps a dominant reflective wavelength of the reflective material layer in a reflective state, and wherein the cut-off filter layer transmits light in a wavelength range which is reflected by the reflective material layer in the reflective state and absorbs light reflected by the transparent electrodes.

### CROSS-REFERENCE TO RELATED APPLICATION(S)

This application is based upon and claims the benefit of priority of the prior Japanese Patent Application No. 2011-71704 filed on Mar. 29, 2011, the entire contents of which are incorporated herein by reference.

### FIELD

The embodiments discussed herein are related to a reflective display panel.

### BACKGROUND

In electronic paper, display is maintained even when a power supply is turned off, and display content is electrically rewritten. Electronic paper may have significantly low power consumption with which the content of a memory may be displayed even when a power supply is switched off, reflective display which is not a burden on human eyes, and a flexible and thin display medium which has flexibility like non-electronic paper. Electronic paper may be applicable to an electronic book, an electronic newspaper, an electronic poster, or the like.

Related art is disclosed in Japanese Laid-open Patent Publication No. 2001-109012 and Japanese Laid-open Patent Publication No. 2001-075121.

### SUMMARY

According to an aspect of the embodiments, a display panel includes: a reflective display panel including: two substrates disposed so as to face each other; transparent electrodes formed over each of the two substrates; and a reflective material layer, sealed between the two substrates, including a reflection state which changes based on a voltage applied between the transparent electrodes; a light absorption layer disposed on a first surface side of the reflective display panel; and a cut-off filter layer disposed on a second surface side of the reflective display panel, wherein, in a visible wavelength range, a wavelength at which reflection from the transparent electrodes is smallest overlaps a dominant reflective wavelength of the reflective material layer in a reflective state, and wherein the cut-off filter layer transmits light in a wavelength range which is reflected by the reflective material layer in the reflective state and absorbs light reflected by the transparent electrodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary display device;

FIG. 2 illustrates an exemplary display panel;

FIG. 3 illustrates an exemplary spectral reflectance characteristic;

FIG. 4 illustrates an exemplary surface reflectance spectrum;

FIG. 5 illustrates an exemplary transmission spectrum;

FIG. 6 illustrates an exemplary color display panel;

FIGS. 7A and 7B illustrate are graphs describing exemplary reflectance spectrums;

FIG. 8 illustrates an exemplary reflectance spectrum; and

FIG. 9 illustrates an exemplary transmission spectrum.

### DESCRIPTION OF EMBODIMENTS

Display types for electronic paper include an electrophoretic type, a twist ball type, an electrochemical type, a liquid crystal display, and an organic electroluminescent (EL) display. In the electrophoretic type, charged particles move in the air or in a liquid. In the twist ball type, charged particles that are color-coded with two colors rotate. In the electrochemical type, a material having a color that is caused to appear, disappear, or change by means of an electrochemical reaction which occurs when an electric field is applied is disposed between electrodes. An organic electro-luminous (EL) display is a self-luminous display in which thin films including an organic material are disposed between a cathode and an anode. A liquid crystal display is a non-self-luminous display in which a liquid crystal layer is disposed between a pixel electrode and a counter electrode.

Display types for displaying colors on electronic paper include a liquid crystal type and an electrochemical type in which a mode is switched between an optically reflective mode and an optically transmissive mode. These types may be applicable to a multilayer display element. For example, when display panels for three RGB colors are stacked, the maximum pixel area may be utilized, and bright, high-contrast, and good-colored display may be performed. In other types having no transmissive modes, lightness or saturation may be decreased because color filters, which are color-coded with three colors, are disposed on a display surface so as to display colors.

In the liquid crystal type, a cholesteric liquid crystal which selectively reflects a certain wavelength range of light may be used. The wavelength band of light reflected by a cholesteric liquid crystal is wide and includes a wide wavelength range of light. Accordingly, a color filter may be inserted for the purpose of reducing a color shift or cutting noise. Since the color filter removes noise of light reflected by a reflective layer, the color filter may compensate for a color shift which occurs when a color appears. A color shift may occur owing to reflection from a transparent electrode. For example, when light in a wavelength range corresponding to green which is highly visible to human eyes is transmitted, black may be displayed in a black color including magenta because a transparent electrode reflects magenta light including blue and red light. A color may be corrected by adjusting a reflectivity of a reflective layer in a reflective state. When black is displayed by using a reflective layer in a non-reflective state (transmissive state), which is provided for a panel having a black layer disposed on the backside of the panel, black may include a color close to red or blue owing to a remaining color that is generated by reflection from a transparent electrode, resulting in degradation in quality of display of black.

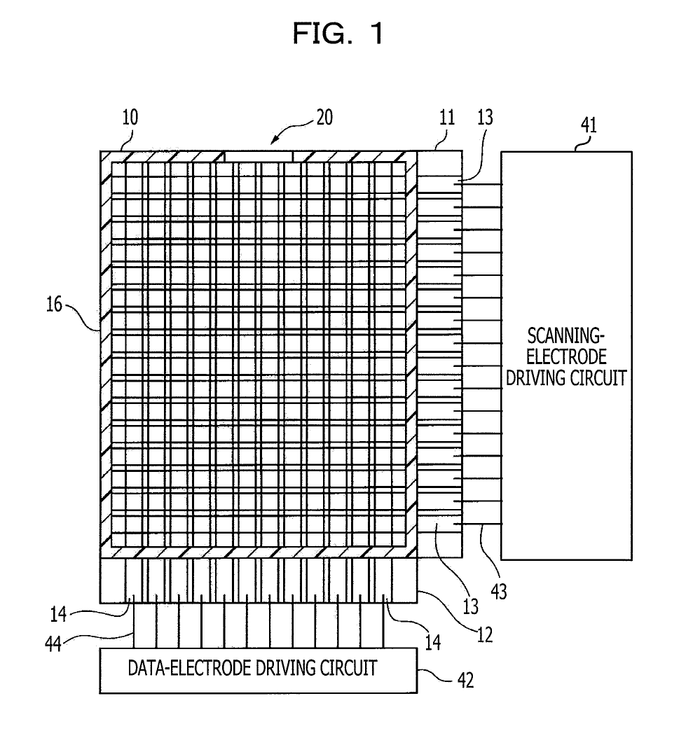

FIG. 1 illustrates an exemplary display device. The display device illustrated in FIG. 1 may be a display device using a cholesteric liquid crystal. The display device includes a display panel 10 using a cholesteric liquid crystal, a scanning-electrode driving circuit 41, and a data-electrode driving circuit 42.

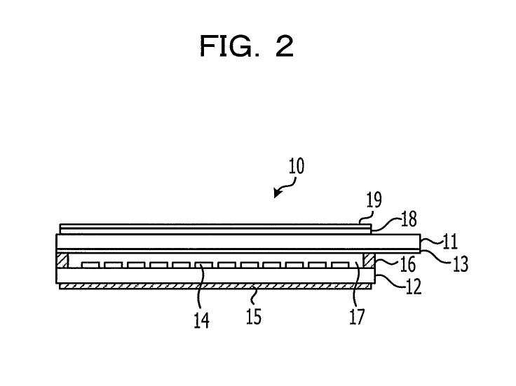

FIG. 2 illustrates an exemplary display panel. Fid.2 illustrates a cross section of a display panel 10. The display panel 10 illustrated in FIG. 2 may be used in the display device illustrated in FIG. 1.

FIG. 1 illustrates the display panel 10 viewed in a direction perpendicular to substrates of the display panel 10. Referring to FIGS. 1 and 2, in the display panel 10, an upper-side substrate 11, on which a plurality of scanning electrodes 13 are formed parallel with each other, and a lower-side substrate 12, on which a plurality of data electrodes 14 are formed parallel with each other, are disposed so as to face each other, and a space between the upper-side and lower-side substrates 11 and 12 is filled with a liquid crystal. A black light absorption layer 15 is disposed on the backside of the display panel 10. A surface-side functional layer 19 is bonded by a transparent adhesion layer 18 on the viewer side of the display panel 10.

The scanning electrodes 13 and the data electrodes 14 each may be a transparent electrode, and may be disposed so as to be orthogonal to each other when viewed in the direction perpendicular to the upper-side and lower-side substrates 11 and 12. Regions in which the scanning electrodes 13 intersect the data electrodes 14 may be defined as pixel regions. A plurality of pixel electrodes are arranged in a matrix. A seal 16 is disposed between the upper-side and lower-side substrates 11 and 12 so as to surround the pixel regions. An internal space surrounded by the seal 16 is filled with a cholesteric liquid crystal material, thereby forming a liquid crystal layer 17. An inlet 20 is provided for filling the internal space with the cholesteric liquid crystal material, which is surrounded by the seal 16, and may be sealed after the filling of the cholesteric liquid crystal material.

The scanning-electrode driving circuit 41 includes general-purpose driver integrated circuits (ICs) for a super-twisted nematic (STN) display having a tape carrier package (TCP) structure, for example, and drives the scanning electrodes 13. Output terminals of the scanning-electrode driving circuit 41 are coupled to the scanning electrodes 13 with wiring 43 formed on a flexible circuit. The data-electrode driving circuit 42 includes general-purpose driver ICs for the STN display having a TCP structure, and drives the data electrodes 14. Output terminals of the data-electrode driving circuit 42 are coupled to the data electrodes 14 with wiring 44 formed on a flexible circuit. Circuits (not illustrated) are disposed so as to supply a power source and control signals to the scanning-electrode driving circuit 41 and the data-electrode driving circuit 42.

The data electrodes 14 may be formed on the upper-side substrate 11, and the scanning electrodes 13 may be formed on the lower-side substrate 12.

The liquid crystal material may be a cholesteric liquid crystal in which 10 to 40 wt % of a chiral material is added to a nematic liquid crystal mixture. The added percentage of the chiral material may be expressed by a value set when the sum of the amount of the nematic liquid crystal component and that of the chiral material is 100 wt %. The color of reflected light or other various properties may be set in accordance with the compound ratio of the chiral material to the nematic liquid crystal component.

A known material may be used as the nematic liquid crystal component. To reduce the drive voltage of the liquid crystal layer 17, the dielectric anisotropy Δε of the nematic liquid crystal component may satisfy 20≦Δε≦50. The refractive index anisotropy Δn of the cholesteric liquid crystal may satisfy 0.18≦Δn≦0.24. When the refractive index anisotropy Δn is below this range, the liquid crystal layer 17 may have a lower reflectivity in a planar state. When the refractive index anisotropy Δn is above the range, the liquid crystal layer 17 may have a lower response speed because the liquid crystal layer 17 has larger scattering reflection as well as a higher viscosity in a focal conic state.

To maintain uniform thickness of the liquid crystal layer 17, for example, a uniform cell gap, spherical spacers including resin or inorganic oxide may be dispersed over the entire display surface, or columnar spacers may be formed in the liquid crystal layer 17. The cell gap d of the liquid crystal layer 17 may satisfy 2 μm≦d≦8 μm. When the cell gap d is below this range, the liquid crystal layer 17 may have a lower reflectivity in the planar state. When the cell gap d is above the range, a drive voltage for the liquid crystal layer 17 may increase.

The upper-side and lower-side substrates 11 and 12 may be a transparent base material. A glass or resin base material may be used as the transparent substrate. Cycloolefin resins, glass base materials, such as quartz glass, soda glass, and borosilicate glass, polyethylene terephthalates (PETs), polyethylene naphthalates (PENs), polycarbonates (PCs), polyether sulphones (PESs), polysulfones (PSFs), and products, such as ZEONOR, ZEONEX, which are manufactured by Nippon Zeon Corp., and ARTON, which is manufactured by JSR Corp., may be used as the transparent substrate.

The scanning electrodes 13 and the data electrodes 14 may include a known material. For example, a transparent conductive film including oxide, such as indium tin oxide (ITO), indium zinc oxide (IZO), or tin oxide, or a photoconductive film including amorphous silicon or the like may be used. A color reflected by a transparent electrode depends on a material included in the transparent electrode. When transparent electrodes include substantially the same material and have different thicknesses, the colors reflected by these transparent electrodes may be different because an interference color is generated by optical interference.

In a display panel in which a cholesteric liquid crystal is used as a reflective layer, an insulator film (not illustrated) or an alignment film (not illustrated) for controlling an arrangement of liquid crystal molecules may be coated on transparent electrodes so as to serve as a functional film. The insulator film may reduce the occurrence of short circuits between electrodes that face each other, and may improve reliability of the display panel as a gas barrier layer. An organic film including polyimide resin, polyamide-imide resin, polyetherimide resin, polyvinyl butyral resin, acrylic resin, or the like, or an inorganic material, such as silicon oxide or aluminum oxide, may be used as the alignment film.

The liquid crystal layer 17 in the display panel 10 is set to the planar state, in which incident light is reflected, or to the focal conic state, in which incident light is transmitted, on a pixel-by-pixel basis in accordance with voltages applied between the scanning electrodes 13 and the data electrodes 14.

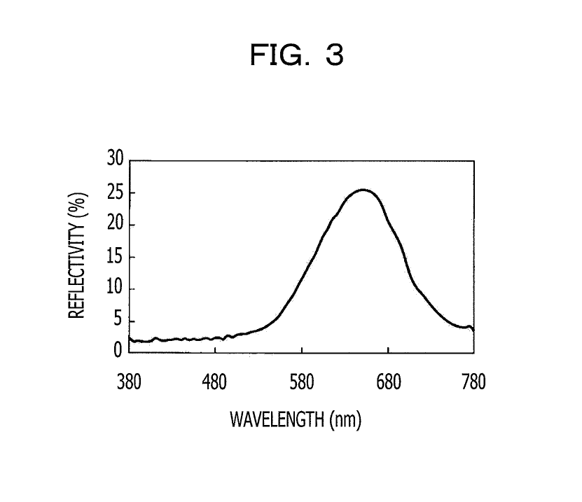

FIG. 3 illustrates an exemplary spectral reflectance characteristic. FIG. 3 illustrates a spectral reflectance characteristic exhibited when the liquid crystal layer 17 is in the planar state. The spectral reflectance characteristic illustrated in FIG. 3 is obtained by measuring a reflectance spectrum with a spectrophotometer in a state where a measurement beam enters the liquid crystal layer 17 from a light source which is disposed at an angle of 30° with respect to a direction perpendicular to the display surface, and where a photoreceiver is disposed at an angle of 0° with respect to the direction perpendicular to the display surface, for example, directly above the display surface. Light reflected by a white board may be used as a reference beam. The spectral reflectance characteristic of a liquid crystal layer may be measured in a substantially similar way.

As illustrated in FIG. 3, the liquid crystal layer 17 in the planar state may have a relatively high reflectivity over a wavelength range from 550 to 780 nm in which the center wavelength is positioned near 660 nm. A center wavelength for reflection may be referred as a dominant reflective wavelength.

The upper-side and lower-side substrates 11 and 12 may include polycarbonate. The scanning electrodes 13 and the data electrodes 14 may include an IZO layer having a film thickness of 170 nm.

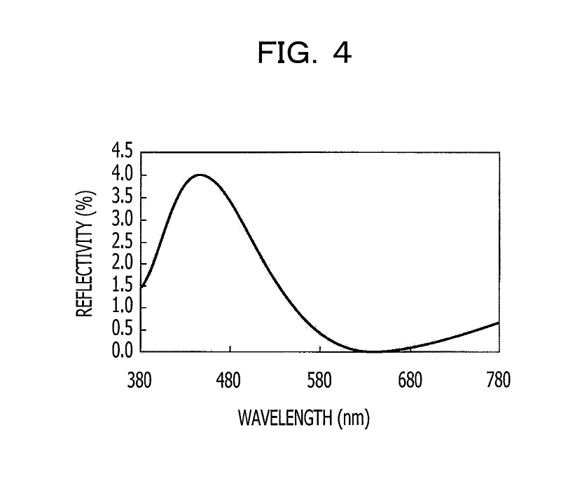

FIG. 4 illustrates an exemplary surface reflectance spectrum. FIG. 4 may illustrate a surface reflectance spectrum of the scanning electrode 13 and the data electrode 14. The surface reflectance spectrum illustrated in FIG. 4 is obtained by measuring a reflectance spectrum with a spectrophotometer in a state where a measurement beam enters the scanning electrode 13 and the data electrode 14 from a light source which is disposed at an angle of −7.5° with respect to a direction perpendicular to the surfaces of the scanning electrode 13 and the data electrode 14, and where a photoreceiver is disposed at an angle of +7.5° with respect to the direction perpendicular to the electrode surfaces, for example. The measurement beam which directly enters the photoreceiver from the light source may be used as a reference beam. The surface reflectance spectrum of an electrode may be measured in a substantially similar way.

As illustrated in FIG. 4, the reflectivity becomes lowest near 640 nm, and becomes highest near 450 nm in a visible range. The reflectance spectrum of the scanning electrode 13 and the data electrode 14 may exhibit a relatively high reflectivity over a range from blue to green.

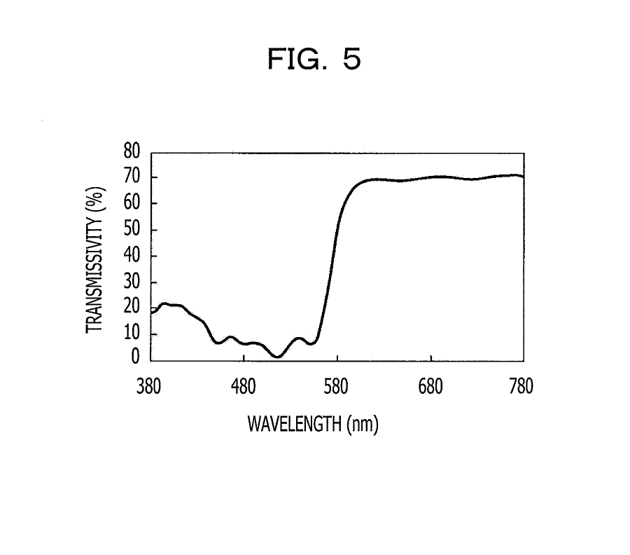

FIG. 5 illustrates an exemplary transmission spectrum. The transmission spectrum illustrated in FIG. 5 may be a transmission spectrum of the surface-side functional layer 19. In the surface-side functional layer 19, a cut-off filter is bonded to a transparent base material. A measurement beam enters the surface-side functional layer 19 from a light source which is disposed at an angle of 180° with respect to a direction perpendicular to the surface of the cut-off filter, for example, directly below the filter surface, and the emitted beam which is transmitted through the filter surface is measured at an angle of 0° with respect to the direction perpendicular to the filter surface, for example, directly above the filter surface. The measurement beam from the light source, which is transmitted only through the transparent base material, may be used as a reference beam. The transmission spectrum of a filter may be measured in a substantially similar way.

As illustrated in FIG. 5, the transmission spectrum of the surface-side functional layer 19 exhibits high transmissivity over a range equal to or larger than 580 nm, and low transmissivity over a range below 580 nm in a visible range. For example, the surface-side functional layer 19 may be a color filter through which red light is transmitted and which absorbs blue to green light.

The surface-side functional layer (cut-off filter layer) 19 may be formed by any method. For example, a transparent board of resin, glass, or the like, which has a color tint using a dye for absorbing a certain wavelength range of light, may be attached to the front surface of the display panel with the transparent adhesion layer 18. Instead, an adhesive sheet having a color tint may be bonded to the front surface of the display panel. Ink or a color resist having the above-described dye may be applied on the display panel surface. The upper-side substrate 11 on which transparent electrodes are formed may have a color tint. A cut-off filter layer may be deposited on the upper-side substrate 11 on which transparent electrodes are formed. A substrate on which transparent electrodes are formed may be used.

When the liquid crystal layer 17 is in the transmissive state, a certain light component of incident light is transmitted through the liquid crystal layer 17 and is absorbed by the light absorption layer 15. Thus, a black color is displayed. When the surface-side functional layer 19 is not provided, part of a blue to green light component (which corresponds to a reflectivity) may be reflected owing to the reflection of the transparent electrodes, for example, the scanning electrodes 13 and the data electrodes 14, and a dark color including blue may be displayed, resulting in degradation in quality of display of black. When the liquid crystal layer 17 is in the reflective state, a red light component of incident light is reflected by the liquid crystal layer 17, and the remaining light components are transmitted through the liquid crystal layer 17 and are absorbed by the light absorption layer 15. Thus, a red color is displayed. When the surface-side functional layer 19 is not provided, part of a blue to green light component (which corresponds to a reflectivity) may be reflected owing to the reflection of the transparent electrodes, for example, the scanning electrodes 13 and the data electrodes 14, and a color having low saturation, in which a blue color is mixed into a red color, may be displayed, resulting in degradation in display quality.

For example, since a blue to green component of incident light is absorbed by the surface-side functional layer 19, only a red component, which is reflected by the liquid crystal layer 17 and is used for display, may enter the panel. The amount of the blue to green light component reflected by the transparent electrodes, for example, the scanning electrodes 13 and the data electrodes 14, may be reduced. When a black color is displayed with the liquid crystal layer 17 in the transmissive state, the black color may not include blue, and a black color may be displayed with high quality. When a red color is displayed with the liquid crystal layer 17 in the reflective state, the red color may not include blue, and a red color having a high saturation may be displayed. Since the surface-side functional layer 19 does not absorb a red component which is reflected by the liquid crystal layer 17 and which is used for display, the quality of display luminance may not be decreased.

The liquid crystal layer 17 having the reflectance spectrum illustrated in FIG. 3, for example, a panel for displaying a red color, is employed. However, a panel for displaying another color, such as blue or green, may be employed. In a visible wavelength range, a wavelength at which the reflection from the transparent electrodes, for example, the scanning electrodes 13 and the data electrodes 14, is smallest may be set so as to overlap the dominant reflective wavelength of the liquid crystal layer 17 in the reflective state. The surface-side functional layer provided on the viewer side, for example, the cut-off filter layer 19, may have a spectral transmission characteristic where light in a wavelength range over which light is to be reflected when the liquid crystal layer 17 is in the reflective state is transmitted and light in a wavelength range over which light is reflected by the transparent electrodes is absorbed.

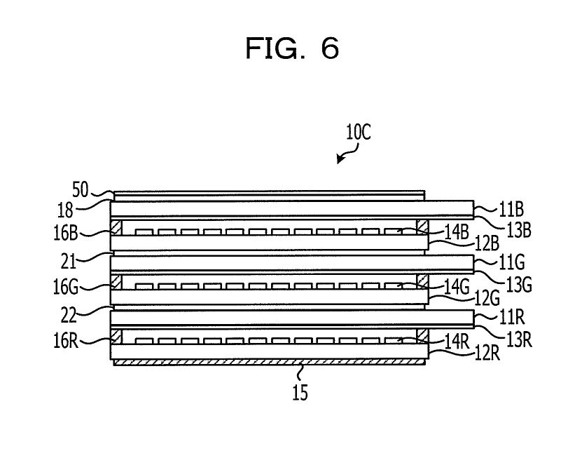

FIG. 6 illustrates an exemplary color display panel 10C. The color display panel 10C illustrated in FIG. 6 may be a color display panel using a cholesteric liquid crystal. The color display panel 10C includes three stacked display panels having a cholesteric liquid crystal. The color display panel 10C also includes the light absorption layer 15 provided on the backside of the color display panel 10C, and a surface-side functional layer 50 attached on the viewer side of the color display panel 10C with the transparent adhesion layer 18. The surface-side functional layer 50 may serve as an anti-glare (AG) layer and a protective film.

Each of the three stacked display panels may have a structure that is substantially the same as or similar to the display panel illustrated in FIG. 2. The dominant reflective wavelength for blue may be 480 nm, that for green may be 550 nm, and that for red may be 650 nm. A panel for blue, a panel for green, and a panel for red may be stacked in this sequence from the viewer side. The panel for blue and the panel for green are attached to each other using a first cut-off filter 21 having an adhesive function. The panel for green and the panel for red are attached to each other using a second cut-off filter 22 having an adhesive function.

In the panel for blue, an upper-side substrate 11B, on which a plurality of scanning electrodes 13B are formed parallel with each other, and a lower-side substrate 12B, on which a plurality of data electrodes 14B are formed parallel with each other, are disposed so as to face each other, and a space between the upper-side and lower-side substrates 11B and 12B is filled with a liquid crystal. A seal 16B is disposed between the upper-side and lower-side substrates 11B and 12B so as to surround the pixel regions. An internal space surrounded by the seal 16B is filled with a cholesteric liquid crystal material, thereby forming a liquid crystal layer for blue. In the panel for green, an upper-side substrate 11G, on which a plurality of scanning electrodes 13G are formed parallel with each other, and a lower-side substrate 12G, on which a plurality of data electrodes 14G are formed parallel with each other, are disposed so as to face each other, and a space between the upper-side and lower-side substrates 11G and 12G is filled with a liquid crystal. A seal 16G is disposed between the upper-side and lower-side substrates 11G and 12G so as to surround the pixel regions. An internal space surrounded by the seal 16G is filled with a cholesteric liquid crystal material, thereby forming a liquid crystal layer for green. In the panel for red, an upper-side substrate 11R, on which a plurality of scanning electrodes 13R are formed parallel with each other, and a lower-side substrate 12R, on which a plurality of data electrodes 14R are formed parallel with each other, are disposed so as to face each other, and a space between the upper-side and lower-side substrates 11R and 12R is filled with a liquid crystal. A seal 16R is disposed between the upper-side and lower-side substrates 11R and 12R so as to surround the pixel regions. An internal space surrounded by the seal 16R is filled with a cholesteric liquid crystal material, thereby forming a liquid crystal layer for red.

The panel for red in the reflective state exhibits the reflectance spectrum illustrated in FIG. 3.

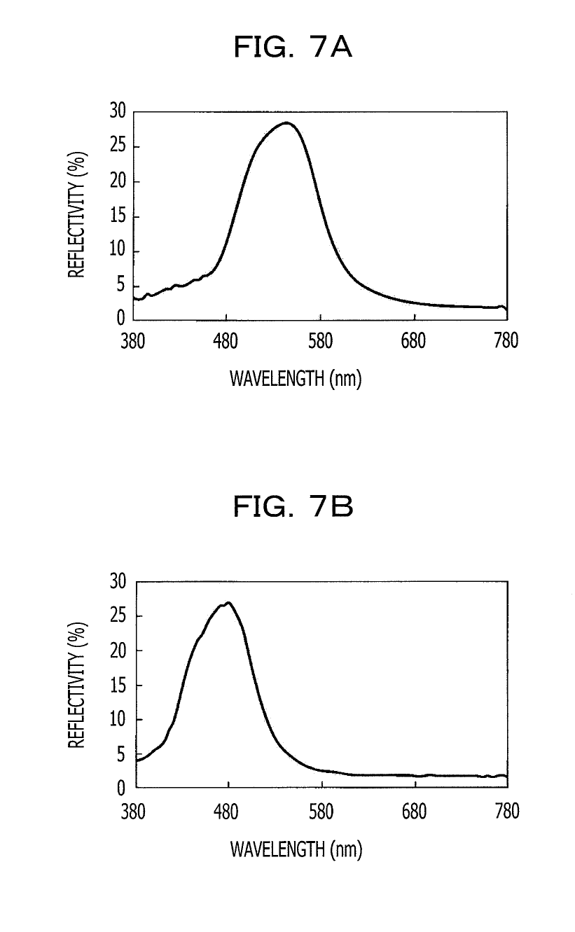

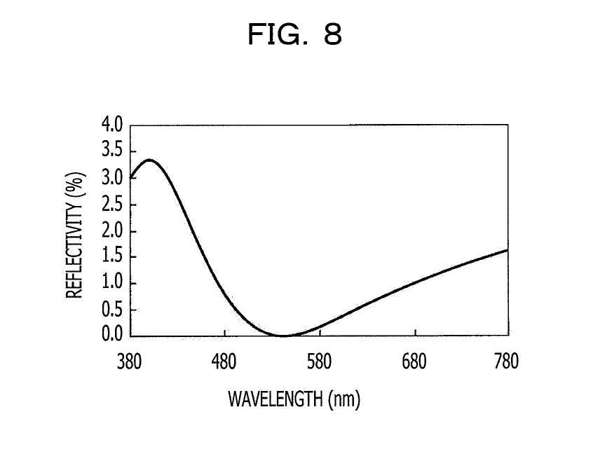

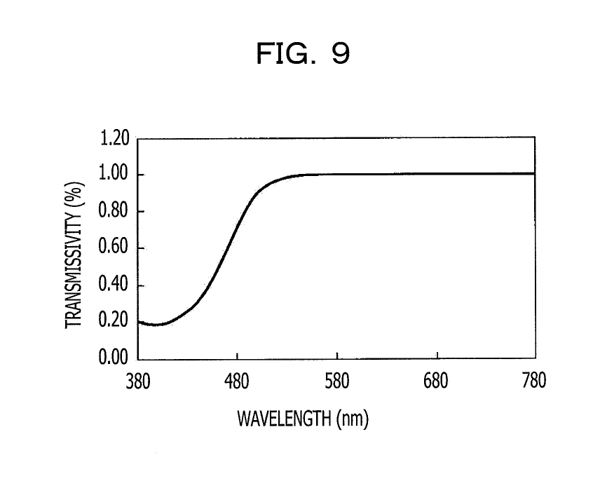

FIGS. 7A and 7B illustrate exemplary reflectance spectrums. FIG. 7A illustrates a reflectance spectrum when the panel for green is set to the reflective state. FIG. 7B illustrates a reflectance spectrum when the panel for blue is set to the reflective state. FIG. 8 illustrates an exemplary reflectance spectrum. FIG. 9 illustrates an exemplary transmission spectrum.

The transparent electrodes in the panel for red, for example, the scanning electrodes 13R and the data electrodes 14R, may be formed of an IZO layer having a film thickness of 170 nm as illustrated in FIG. 2, and may have the reflectance spectrum illustrated in FIG. 4. For example, the transparent electrodes in the panel for red may have a dominant reflective wavelength of 650 nm.

The transparent electrodes in the panel for green, for example, the scanning electrodes 13G and the data electrodes 14G, may be formed of an IZO layer having a film thickness of 150 nm, and may have the reflectance spectrum illustrated in FIG. 8. For example, the transparent electrodes in the panel for green may have a dominant reflective wavelength of 550 nm.

The transparent electrodes in the panel for blue, for example, the scanning electrodes 13B and the data electrodes 14B, may be formed of an IZO layer having a film thickness of 140 nm, and may have a reflectance spectrum obtained by shifting the reflectance spectrum illustrated in FIG. 8 to the shorter wavelength side. For example, the transparent electrodes in the panel for blue may have a dominant reflective wavelength of 530 nm.

The second cut-off filter 22 may have an adhesive function and have the transmission spectrum illustrated in FIG. 5. For example, the transmission spectrum of the second cut-off filter 22 may exhibit high transmissivity over a range equal to or larger than 580 nm, and low transmissivity over a range below 580 nm in a visible range. For example, the second cut-off filter 22 may be a color filter through which red light is transmitted and which absorbs blue to green light.

The first cut-off filter 21 may have an adhesive function and have the transmission spectrum illustrated in FIG. 9. For example, the transmission spectrum of the first cut-off filter 21 exhibits high transmissivity over a range equal to or larger than 480 nm, and low transmissivity over a range below 480 nm in a visible range. For example, the first cut-off filter 21 may be a color filter through which green or red light is transmitted and which absorbs blue light.

Each of the three panels in the color display panel 10C illustrated in FIG. 6 may be driven by the scanning-electrode driving circuit 41 and the data-electrode driving circuit 42 illustrated in FIG. 1. The scanning-electrode driving circuit 41 may be made up of a single circuit, and may drive the scanning electrodes 13B, 13G, and 13R in the three panels together.

In the color display panel 10C illustrated in FIG. 6, the colors reflected by the transparent electrodes in the panel for red disposed as the third panel may be blue to green, and may be cut off by the second cut-off filter 22. The colors reflected by the transparent electrodes in the panel for green disposed as the second panel may be magenta including blue and red, and blue may be cut off by the first cut-off filter 21.

Red may not be cut off among the colors reflected by the transparent electrodes in the panel for blue disposed as the first panel and among the colors reflected by the transparent electrodes in the panel for green disposed as the second panel, and a black color having a blue color and a small amount of a green color may be displayed. Compared with three panels in which light is reflected by transparent electrodes without being cut off, the amount of the light reflected by the transparent electrodes is reduced.

When a black color is displayed in the color display panel 10C illustrated in FIG. 6, for example, when all of the liquid crystal layers in the three panels are in the transmissive state, a color expressed as the relations a*=6.2 and b*=2.4 in the Lab color space may be displayed, and a black color close to an achromatic color may be displayed.

A display panel having a cholesteric liquid crystal is employed. However, other materials may be used to form a reflective material layer in which a display state is switched between an optically transmissive state and an optically reflective state. For example, reflective liquid crystal materials other than a cholesteric liquid crystal, electrochromic materials, or electrodeposition materials may be used. A multilayer display panel having a plurality of display panels which are attached to each other and which have a liquid crystal material having large scattering when light is transmitted through the liquid crystal material may have a large effect.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display panel comprising:
a reflective display panel including:
two substrates disposed so as to face each other;
transparent electrodes formed over each of the two substrates; and
a reflective material layer, sealed between the two substrates, including a reflection state which changes based on a voltage applied between the transparent electrodes,
a light absorption layer disposed on a first surface side of the reflective display panel; and
a cut-off filter layer disposed on a second surface side of the reflective display panel,
wherein, in a visible wavelength range, a wavelength at which reflection from the transparent electrodes is smallest overlaps a dominant reflective wavelength of the reflective material layer in a reflective state, and
wherein the cut-off filter layer transmits light in a wavelength range which is reflected by the reflective material layer in the reflective state and absorbs light reflected by the transparent electrodes.

2. The display panel according to claim 1, wherein the reflective material layer includes a cholesteric liquid crystal.

3. A display panel comprising:
a plurality of reflective display panels stacked each other, each of the plurality of reflective display panels including:
two substrates disposed so as to face each other;
transparent electrodes formed over each of the two substrates;and
a reflective material layer, sealed between the two substrates, including a reflection state which changes based on a voltage applied between the transparent electrodes,
a light absorption layer disposed on a first surface side of the plurality of reflective display panels,
wherein, in a visible wavelength range for each of reflective display panels among the plurality of reflective display panels other than a first reflective display panel disposed nearest to a second surface side of the plurality of reflective display panels, a wavelength at which reflection from the transparent electrodes is smallest overlaps a dominant reflective wavelength of the reflective material layer in a reflective state, and
wherein the cut-off filter layer to transmit light in a wavelength range which is reflected by the reflective material layer in the reflective state and absorb light reflected by the transparent electrodes is disposed at the second surface side of the plurality of reflective display panels.

4. The display panel according to claim 3, wherein dominant reflective wavelengths of the reflective material layers of the plurality of reflective display panels that are arranged from the second surface side correspond to blue, green, and red in a sequence, and
wherein a wavelength at which reflection from the transparent electrodes of the reflective display panel that has a dominant reflective wavelength corresponding to red is smallest corresponds to red.

5. The display panel according to claim 4, wherein a wavelength at which reflection from the transparent electrodes of the reflective display panel that has a dominant reflective wavelength corresponding to green is smallest corresponds to green.

6. The display panel according to claim 5, wherein the cut-off filter layer includes:
a cut-off filter for blue disposed between the reflective display panel having a dominant reflective wavelength corresponding to blue and the reflective display panel having a dominant reflective wavelength corresponding to green; and
a cut-off filter for a color including at least green, the cut-off filter being disposed between the reflective display panel having a dominant reflective wavelength corresponding to green and the reflective display panel having a dominant reflective wavelength corresponding to red.

7. The display panel according to claim 3, further comprising:
an adhesion layer, disposed between the plurality of reflective display panels, to bond the adjacent reflective display panels.

8. The display panel according to claim 7, wherein the adhesion layer includes a color-tinted layer that serves as the cut-off filter layer.

9. The display panel according to claim 3, wherein the reflective material layer includes a cholesteric liquid crystal.

10. A display device comprising:
a plurality of reflective display panels stacked each other, each of the plurality of reflective display panels including:
two substrates disposed so as to face each other;
transparent electrodes formed over each of the two substrates; and
a reflective material layer, sealed between the two substrates, including a reflection state which changes based on a voltage applied between the transparent electrodes,
a light absorption layer disposed on a first surface side of the plurality of reflective display panels;
a scanning-electrode driving circuit that drives a scanning electrode disposed in the display panel; and
a data-electrode driving circuit that drives a data electrode disposed in the display panel,
wherein, in a visible wavelength range for each of reflective display panels among the plurality of reflective display panels other than a first reflective display panel disposed nearest to a second surface side of the plurality of reflective display panels, a wavelength at which reflection from the transparent electrodes is smallest overlaps a dominant reflective wavelength of the reflective material layer in a reflective state, and
wherein the cut-off filter layer to transmit light in a wavelength range which is reflected by the reflective material layer in the reflective state and absorb light reflected by the transparent electrodes is disposed at the second surface side of the plurality of reflective display panels.
